(19) United States
(12) Patent Application Publication
(10) Pub. No.: US 2026/0087179 A1
(43) Pub. Date: Mar. 26, 2026

(54) METHOD OF ACCESSING A SECURITY DEVICE

(71) Applicant: Apple Inc., Cupertino, CA (US)

(72) Inventors: Vamshi Krishna Aileni, San Jose, CA (US); Paul B. Fruhauf, Santa Clara, CA (US)

(73) Assignee: Apple Inc., Cupertino, CA (US)

(21) Appl. No.: 18/895,031

(22) Filed: Sep. 24, 2024

(51) Int. Cl. G06F 21/71

(52) U.S. Cl. CPC G06F 21/71

(57) ABSTRACT

A computer-implemented method, by a reader device, including receiving, from a provisioning device, a full credential key for unlocking a security device, receiving, from a first electronic device, a first sub-credential key generated based at least in part on the full credential key, receiving, from a second electronic device, a second sub-credential key generated based at least in part on the full credential key, generating a constructed credential key based at least in part on the first sub-credential key and the second sub-credential key, determining that the constructed credential key corresponds to the full credential key by comparing the constructed credential key to the full credential key, and unlocking the security device with the constructed credential key based at least in part on the determination that the constructed credential key corresponds to the full credential key.

### BACKGROUND

The development and advancement of wireless communication has led to the utilization of wireless communication for performing many tasks. One such task for which wireless communication has been utilized is opening security devices (e.g., safes or the like). However, there are security challenges in opening security devices with wireless communication.

### BRIEF SUMMARY

One aspect of the disclosure provides for a computer-implemented method, by a reader device, including receiving, from a provisioning device, a full credential key for unlocking a security device, receiving, from a first electronic device, a first sub-credential key generated based at least in part on the full credential key, receiving, from a second electronic device, a second sub-credential key generated based at least in part on the full credential key, generating a constructed credential key based at least in part on the first sub-credential key and the second sub-credential key, determining that the constructed credential key corresponds to the full credential key by comparing the constructed credential key to the full credential key, and unlocking the security device with the constructed credential key based at least in part on the determination that the constructed credential key corresponds to the full credential key.

Implementations may include one or more of the following features. Receiving the first sub-credential key may include receiving the first sub-credential key at a first time and receiving the second sub-credential key may include receiving the second sub-credential key at a second time after the first time. Generating the constructed credential key may include generating the constructed credential key when a first time difference between the second time and the first time is less than a first pre-determined time threshold. Generating the constructed credential key may include generating the constructed credential key based at least in part on the third sub-credential key. Generating the constructed credential key may include generating the constructed credential key when a second time difference between the third time and the second time is less than the first pre-determined time threshold. Generating the constructed credential key may include generating the constructed credential key when a third time difference between the third time and the first time is less than a second pre-determined time threshold different than the first pre-determined time threshold. Generating the constructed credential key may include generating the constructed credential key when the first distance and the second distance are each less than a pre-determined distance threshold. Generating the constructed credential key may include generating the constructed credential key without the third sub-credential key. Receiving the first sub-credential key and the second sub-credential key may include receiving the first sub-credential key and the second sub-credential key through at least one of a near-field communication protocol, a bluetooth low energy protocol, or an ultra-wideband protocol. Receiving the first sub-credential key and the second sub-credential key may include receiving the first sub-credential key and the second sub-credential key through an Aliro protocol. Generating the constructed credential key may include generating the constructed credential key through a process associated with a cryptographic algorithm. Determining that the constructed credential key corresponds to the full credential key may include determining that the constructed credential key matches the full credential key.

One aspect of the disclosure provides for one or more non-transitory computer-readable media may include computer-executable instructions that, when executed by one or more processors, cause the one or more processors to perform operations comprising receiving, by a reader device from a provisioning device, a full credential key for unlocking a security device, receiving, by the reader device from a first electronic device, a first sub-credential key generated based at least in part on the full credential key, receiving, by the reader device from a second electronic device, a second sub-credential key generated based at least in part on the full credential key, generating, by the reader device, a constructed credential key based at least in part on the first sub-credential key and the second sub-credential key, determining, by the reader device, that the constructed credential key corresponds to the full credential key by comparing the constructed credential key to the full credential key, and unlocking, by the reader device, the security device with the constructed credential key based at least in part on the determination that the constructed credential key corresponds to the full credential key.

Implementations may include one or more of the following features. Receiving the first sub-credential key may include receiving the first sub-credential key at a first time and receiving the second sub-credential key may include receiving the second sub-credential key at a second time after the first time. Generating the constructed credential key may include generating the constructed credential key when a first time difference between the second time and the first time is less than a first pre-determined time threshold. Generating the constructed credential key may include generating the constructed credential key based at least in part on the third sub-credential key. Generating the constructed credential key may include generating the constructed credential key when a second time difference between the third time and the second time is less than the first pre-determined time threshold. Generating the constructed credential key may include generating the constructed credential key when a third time difference between the third time and the first time is less than a second pre-determined time threshold different than the first pre-determined time threshold. Generating the constructed credential key may include generating the constructed credential key when the first distance and the second distance are each less than a pre-determined distance threshold.

One aspect of the disclosure provides for a system including a memory that has computer-executable instructions. The system also may include a processor configured to access the memory and execute the computer-executable instructions to at least receive, by a reader device from a provisioning device, a full credential key for unlocking a security device, receive, by the reader device from a first electronic device, a first sub-credential key generated based at least in part on the full credential key, receive, by the reader device from a second electronic device, a second sub-credential key generated based at least in part on the full credential key, generate, by the reader device, a constructed credential key based at least in part on the first sub-credential key and the second sub-credential key, determine, by the reader device, that the constructed credential key corresponds to the full credential key by comparing the constructed credential key to the full credential key, and unlock, by the reader device, the security device with the constructed credential key based at least in part on the determination that the constructed credential key corresponds to the full credential key.

Implementations may include one or more of the following features. Receiving the first sub-credential key may include receiving the first sub-credential key at a first time and receiving the second sub-credential key may include receiving the second sub-credential key at a second time after the first time. Generating the constructed credential key may include generating the constructed credential key when a first time difference between the second time and the first time is less than a first pre-determined time threshold. Generating the constructed credential key may include generating the constructed credential key when the first distance and the second distance are each less than a pre-determined distance threshold.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a block diagram showing an example security device access environment, according to at least one example.

FIG. 2 illustrates a swim lane diagram showing example processes for access a security device, according to at least one example.

FIG. 3 illustrates a block diagram showing example user devices transmitting sub-credential keys at different distances, according to at least one example.

FIG. 4A illustrates a block diagram showing an example first user device transmitting a first sub-credential key at a first time, according to at least one example.

FIG. 4B illustrates a block diagram showing an example second user device transmitting a second sub-credential key at a second time, according to at least one example.

FIG. 4C illustrates a block diagram showing an example third user device transmitting a third sub-credential key at a third time, according to at least one example.

FIG. 5 illustrates an example flowchart for accessing a security device, according to at least one example.

FIG. 6 illustrates a simplified block diagram depicting an example architecture for implementing the techniques described herein, according to at least one example.

FIGS. 7A and 7B illustrate methods of application processes, in accordance with some embodiments.

FIG. 7C illustrates a device for implementing an API, in accordance with some embodiments.

FIG. 7D illustrates a system for implementing an API, in accordance with some embodiments.

FIGS. 7E and 7F illustrate data flows related to API processes, in accordance with some embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Examples of the present disclosure are directed to, among other things, methods, systems, devices, and computer-readable media that provide techniques for more securely accessing security devices, such as a safe, lockbox, vault, or other containers that can store valuable assets. For example, some security devices can require multiple credential keys to open the lock box to increase the security of the security device. The security device can be electronically coupled to a reader device that can unlock the security device once the reader device receives a combination of digital credential keys. In use, multiple user devices (e.g., user devices of a family member and an employee of the establishment housing the security device) may present corresponding credential keys to the reader device. In conventional systems, the reader device may transmit all the credential keys to a separate device for that separate device to verify whether the combination of the credential keys can open the security device. However, sending those credential keys to that separate device can increase the likelihood that the credential keys are captured by malicious actors and later used to open the security device without the consent of the owner of the security device.

The techniques described herein provide an improved method of more securely opening the security device by having the reader device verify whether the combination of the credential keys can open the security device, rather than transmitting the credential keys to a separate device for verification. Specifically, an issuing device may transmit a full credential key to a provisioning device. The provisioning device may divide the full credential key into multiple sub-credential keys. The provisioning device may send the full credential key to a reader device that electronically controls access to a security device. The provisioning device may send the sub-credential keys to different user devices. To open the security device, the sub-credential keys can be transmitted to the reader device within certain limitations (e.g., presented within a certain distance, time, order, or the like). The reader device can reconstruct the sub-credential keys into a constructed credential key and compare that credential key to the full credential key transmitted by the provisioning device to verify whether the communicated sub-credential keys can unlock the security device.

The systems, devices, and techniques described herein provide several technical advantages that improve the security of opening security devices. For example, verifying whether sub-credential keys can unlock the security on the reader device, rather than with a separate entity in communication with the reader device, can minimize the risk that those sub-credential keys are captured and used by malicious actors.

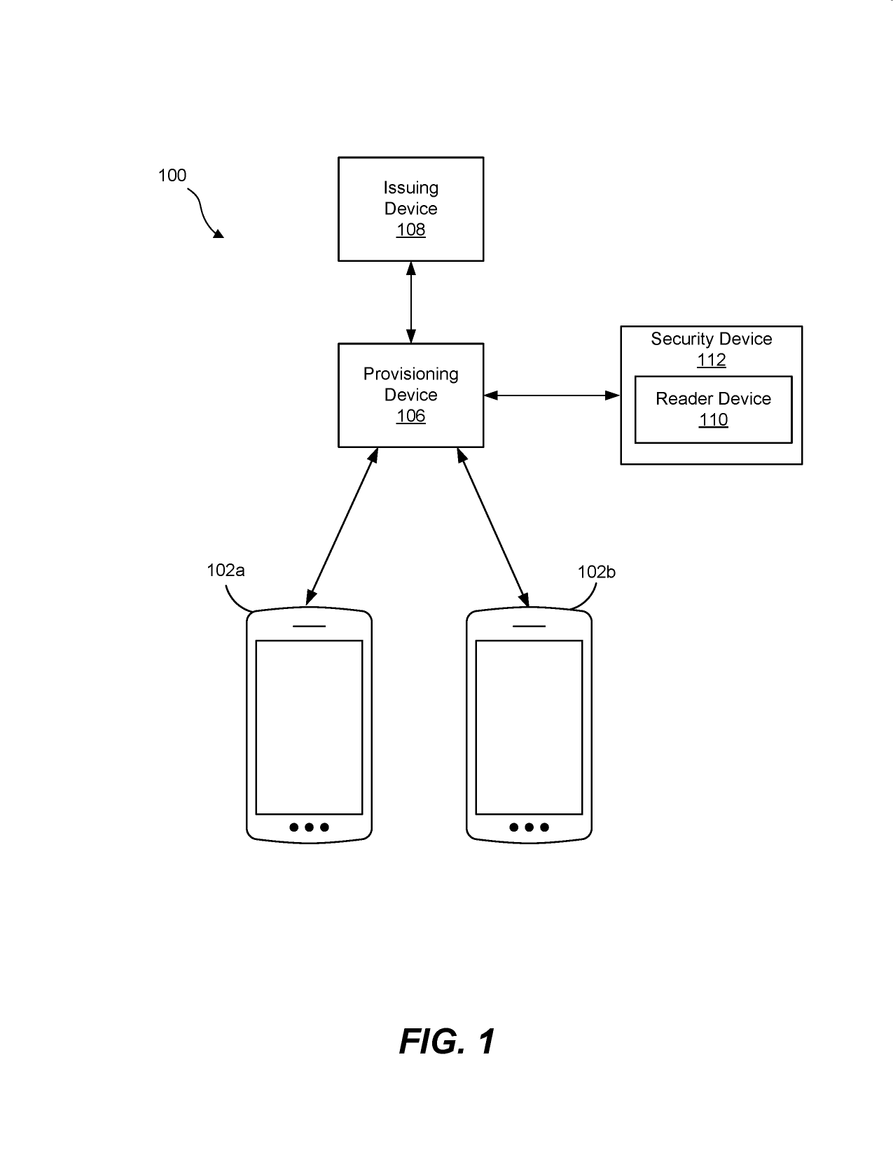

Turning now to the figures, FIG. 1 depicts a block diagram showing a security device access environment 100, according to at least one example. The processes, and any other processes described herein. Each operation of which represents a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures and the like that perform particular functions or implement particular data types. The order in which the operations are described is not intended to be construed as a limitation, and any number of the described operations can be combined in any order and/or in parallel to implement the processes.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

The security device access environment 100 may include an issuing device 108. The issuing device 108 may include a computing device such as a server, a portion of a distributed computing device, or the like. The issuing device 108 can store and manage data associated with a security device, such as a full credential key that can grant access to a security device 112. A credential key can be a type of access token or authentication device that grants authorized access to locked systems, networks, and/or physical spaces. For example, the credential keys can grant authorized access to security devices, such as a safe, lockbox, vault, or the like.

The issuing device 108 may communicate with a provisioning device 106 (e.g., through wireless communications, such as Bluetooth, WiFi, the Internet, or the like). The provisioning device 106 may include a computing device such as a server, a portion of a distributed computing device, or the like. The issuing device 108 can transmit data to and from the provisioning device 106 (e.g., the full credential key). The provisioning device 106 can split the full credential key into multiple sub-credential keys according to an agreed upon algorithm such that the sub-credential keys can be transmitted between devices using near-field communication (NFC), Bluetooth® low energy (BLE), ultra-wideband (UWB), or other communication protocols. For example, the provisioning device 106 can split the full credential key using a cryptographic algorithm, such as Shamir’s secret sharing algorithm, XOR sharing, or the like. The sub-credential keys can be a type of access token or authentication device that can algorithmically be combined to form a different credential key (e.g., a constructed credential key corresponding to the full credential key).

The provisioning device 106 may communicate with a first user device 102a and a second user device 102b. The user devices 102a, 102b may be a cellular phone, a tablet computing device, a laptop computer, a watch-based computing device, or the like. The user devices 102a, 102b can include memory to store sub-credential keys and communications systems to transmit those sub-credential keys with other devices (e.g., by tapping or otherwise wireless communicating with the other devices). Although FIG. 1 depicts two user devices 102a, 102b, in communication with the provisioning device 106, in other embodiments, there may be more than two user devices, such as three, four, five, or the like. The provisioning device 106 can transmit the sub-credential keys to the user devices 102a, 102b. In particular, the provisioning device 106 can transmit one sub-credential key to each of the user devices 102a, 102b. Each of the sub-credential keys can be different from each other. Two or more of the sub-credential keys can, later, be combined to form a reconstructed credential key by other devices.

The provisioning device 106 may also communicate with a reader device 110 of the security device 112. The reader device 110 may include a desktop computing device or server, or the reader device 110 may also include a mobile device, such as a cellular phone, a tablet computing device, a laptop computer, etc. The reader device 110 may include a computing device capable of sending and receiving data utilizing one or more communication protocols. For example, the reader device 110 can receive the full credential key from the provisioning device 106 while also being able to receive sub-credential keys from other devices (e.g., the user devices 102a, 102b) using one or more of the communication protocols mentioned above. The reader device 110 may also be able to determine whether the sub-credential keys are received under certain conditions (e.g., certain time thresholds, distance thresholds, and/or order requirements). Additionally, the reader device 110 can be capable of reconstructing two or more sub-credential keys into a reconstructed key to compare with the full credential key. The reader device 110 may control access to the security device 112 (e.g., whether to lock or unlock the security device 112). The reader device 106 may form a part of the security device 112, however, in other embodiments, the reader device may be a separate device spaced from the security device.

As will be discussed further below, the reader device 110 may be capable of combining sub-credential keys into a reconstructed credential key. The reader device 110 may compare the reconstructed credential key with the full credential key received from the provisioning device 106. Based on this comparison, the reader device 110 can verify whether the transmitted sub-credential keys can unlock the security device 112. As noted above, performing this verification with the reader device 110 can improve the security of unlocking the security device 110 by minimizing the risk that those sub-credential keys are captured and used by malicious actor.

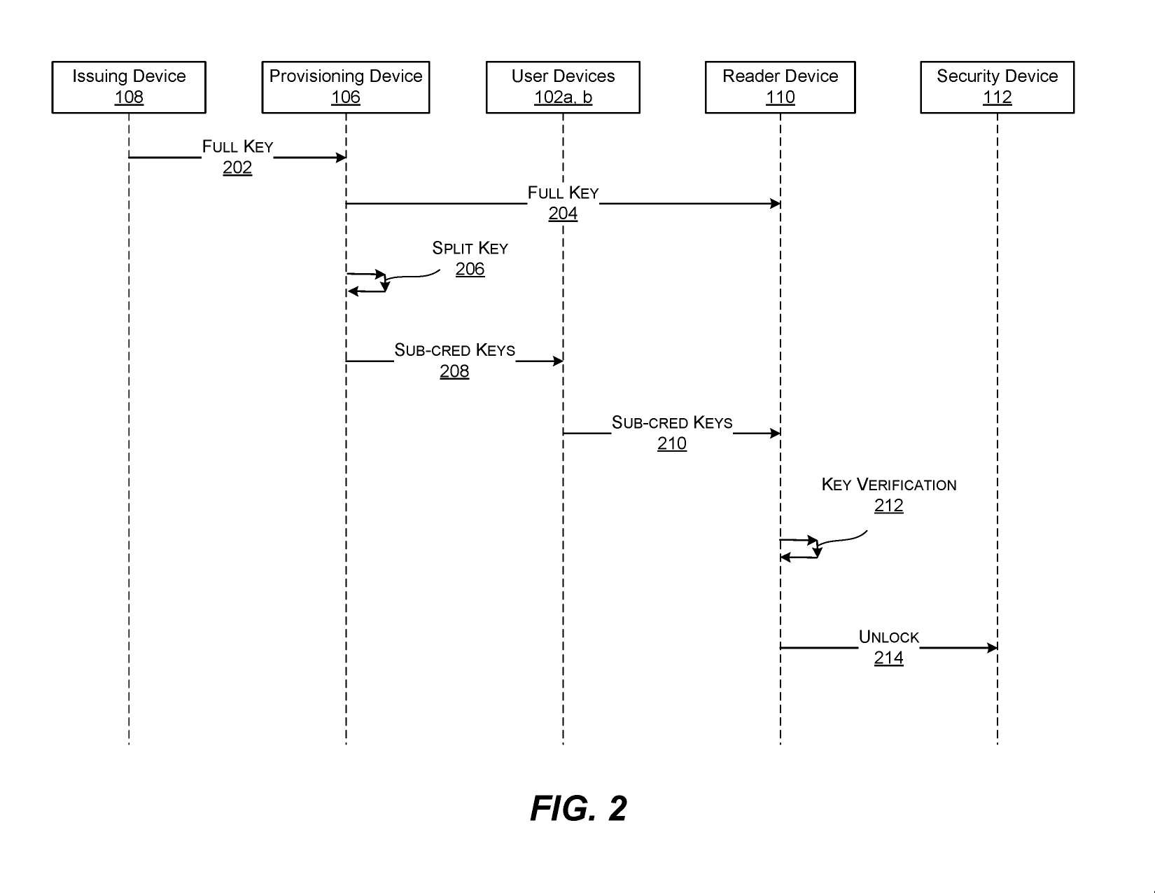

FIG. 2 is a swim lane diagram illustrating a method for unlock a security device using the electronic devices of FIG. 1. At step 202, the issuing device 108 can transmit a full credential key to the provisioning device 106. As noted above, the full credential key can be used to unlock the security device 112.

At step 204, the provisioning device 106 can transmit the full credential key to the reader device 110. The reading device 110 may open the security device 112 when the reading device 110 reconstructs a credential key that corresponds with the full credential key received by the provisioning device 106, as discussed further below. In other embodiments, the issuing device can transmit the full key to the reader device instead of, or in addition to, the provisioning device transmitting the full credential key to the reader device. In other examples, the issuing device and the provisioning device are a part of the same device.

At step 206, the provisioning device 106 can split the full credential key into sub-credential keys according to a communication protocol. For example, the provisioning device 106 can split the full credential key according to an agreed upon algorithm such that sub-credential keys that are transmittable between devices using one or more of NFC, BLE, UWB, or the like. Each of the sub-credential keys can be different from each other. The use of only a single sub-credential key by other devices would not be successful in trying to access the security device 112. Instead, in order to access the security device 112, as discussed further below, at least two or more of the sub-credential keys can be algorithmically combined to form a constructed key that correspond to the full credential key. In some examples, the provisioning device 106 can use a cryptographic algorithm, such as Shamir’s secret sharing algorithm, XOR sharing, or the like.

In some embodiments, the provisioning device 106 may split the full credential key upon request. For example, one or more of the user devices 102a, 102b or reader device 110 may request for the provisioning device 106 to transmit the sub-credential keys. In response, the provisioning device 106 may generate the sub-credential keys by splitting the full credential key for transmission. In one particular example, the reader device 110 may request for the provisioning device 106 to split the full credential key after receiving the full credential key from the provisioning device 106 at step 204. However, in other embodiments, the provisioning device may not split the full credential key upon request and, instead, may automatically split the full credential key for transmission once the provisioning device receives the full credential key from the issuing device.

At step 208, the provisioning device 106 can transmit the sub-credential keys to the user devices 102a, 102b to initiate an access attempt to access the security device 112. For example, the provisioning device 106 can transmit a first sub-credential key to the first user device 102a and a second sub-credential key to the second user device 102b. In some embodiments, the provisioning device 106 can split and send the full credential key at the same time as sending the full credential key to the reader device. However, in other embodiments, the provisioning device can split and send the full credential key at different times as sending the full credential key (e.g., splitting and sending the full credential key after sending the full credential key).

At step 210, one or more of the user devices 102a, 102b, can transmit their corresponding sub-credential key to the reader device 110 for the reader device 110 to verify that the users of the user devices 102a, 102b are authorized to access the security device 112. In one use case, a family member may seek to unlock the security device 112 (e.g., a family-owned lockbox) stored in a bank. The family member may use the first user device 102a and a bank employee may use the second user device 102b. In this example, neither of the sub-credential key stored on the first user device 102a and the second sub-credential key stored on the second user device 102b may, individually, be used to access the security device 112. Instead, the user devices 102a, 102b can transmit the sub-credential keys to the reader device 110 for use to unlock the security device 112. The sub-credential key can be transmitted using according to an Aliro™ protocol (e.g., an Aliro™ StepUp transaction).

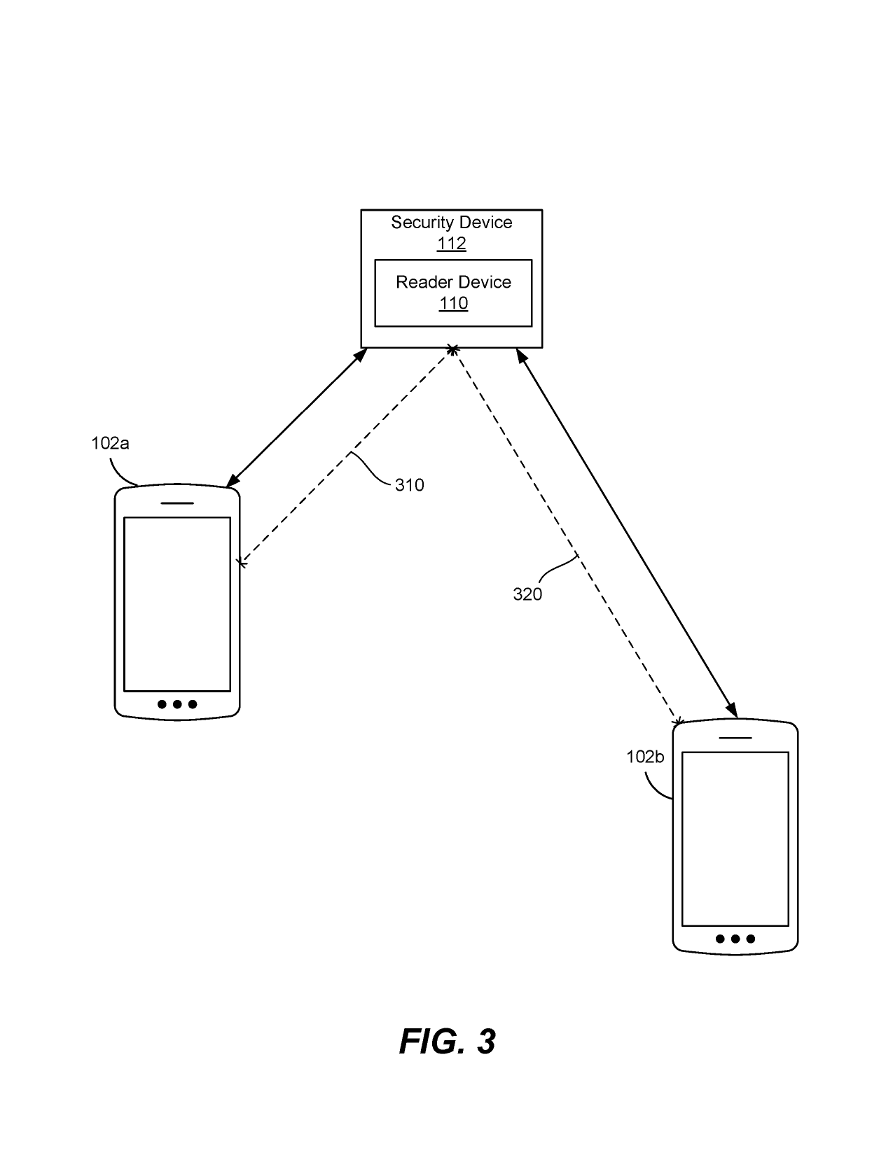

The reader device 110 may accept sub-credential keys for use in generating the constructed credential key where the sub-credential keys are transmitted under one or more communication conditions before generating the constructed credential key. For example, the reader device 110 may require the user devices 102a, 102b to be positioned within a distance threshold from the reader device 110 to ensure that all authorized user devices 102a, 102b (and, by extension, the authorized users of the user devices 102a, 102b) be present when the security device 112 is unlocked, thus minimizing the risk that the security device 112 is accessed by malicious actors. FIG. 3 depicts the user devices 102a, 102b transmitting the sub-credential keys to the reader device 110 at different distances. Specifically, the first user device 102a may transmit the first sub-credential key at a first distance 310 from the reader device 106 and the second user device 102b may transmit the second sub-credential key at a second distance 320 from the reader device 106. The second distance 320 may be greater than the first distance 310. It is understood that the distances 310, 320 depicted are illustrative only.

The reader device 110 may not accept the sub-credential key for use in generating the credential key where the corresponding user device 102a, 102b is positioned farther than a distance threshold. The distance threshold can be a pre-determined distance, such as 1 foot, 3 feet, 5 feet, 10 feet, or the like. For example, the first distance 310 may be within (e.g., less than) the distance threshold for the reader device 110 to accept the first sub-credential key from the first user device 102a while the second distance 320 may not be within the distance threshold. In this example, the reader device 110 may not construct the credential key as only the first sub-credential key is accepted by the reader device 110. On the other hand, the reader device 110 may accept both of the sub-credential keys where both distances 310, 320 are within the distance threshold. Accordingly, even though the second distance 320 is greater than the first distance 310, if both of the distances 310, 320 are within the distance threshold, the reader device 110 may accept both sub-credential keys.

The distances 310, 320 may be determined corresponding to the communication protocol used when generating the sub-credential keys. For example, where the provisioning device 106 generated the sub-credential keys according to a BLE communication protocol, the distances 310, 320 may be determined based on a signal strength between the user devices 102a, 102b and the reader device 110. Where the provisioning device 106 generated the sub-credential keys according to an NFC communication protocol, the distances 310, 320 may be determined based on the relative magnetic field between the user devices 102a, 102b and the reader device 110. Where the provisioning device 106 generated the sub-credential keys according to a UWB communication protocol, the distances 310, 320 may be determined based on the time of flight of radio signals between the user devices 102a, 102b and the reader device 110.

For certain communication protocols, the reader device 110 may not include a distance threshold. For example, where the sub-credential keys were split to allow for NFC communication, the reader device 110 may not include a distance threshold because, in order for the user devices 102a, 102b to transmit the sub-credential keys, the user devices 102a, 102b would have to get close enough to the reader device 110 as to satisfy any distance threshold the reader device 110 may otherwise have had (e.g., by tapping or otherwise physically coupling the user devices 102a, 102b to the reader device 110). However, in some embodiments, the reader device may still include a distance threshold even with NFC communication.

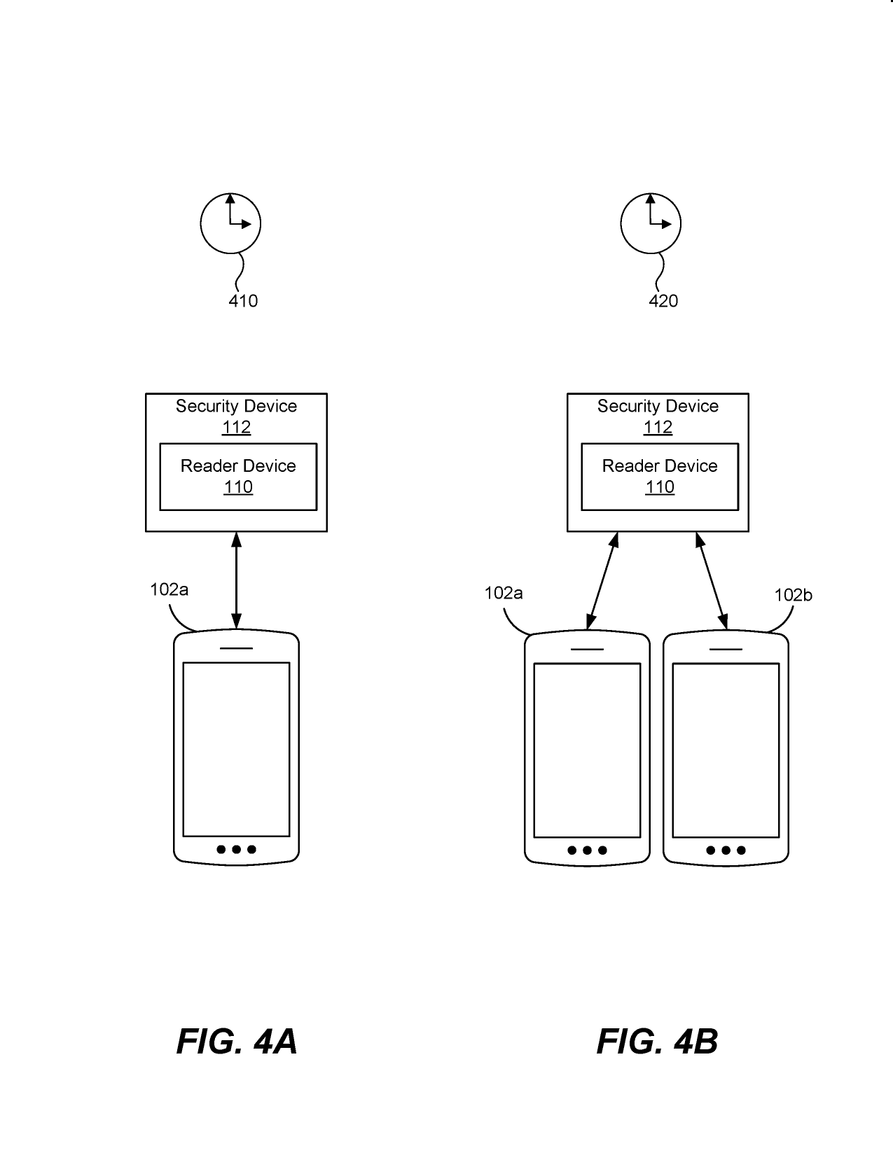

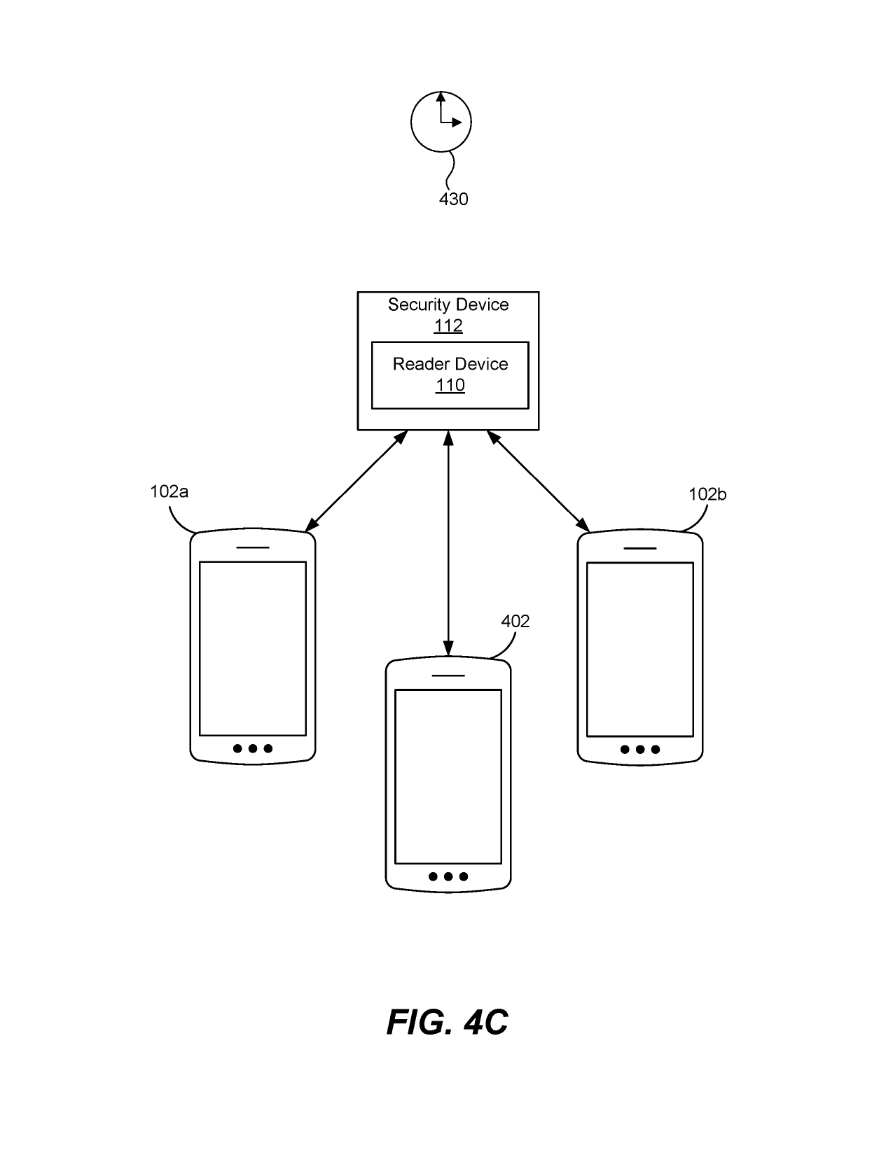

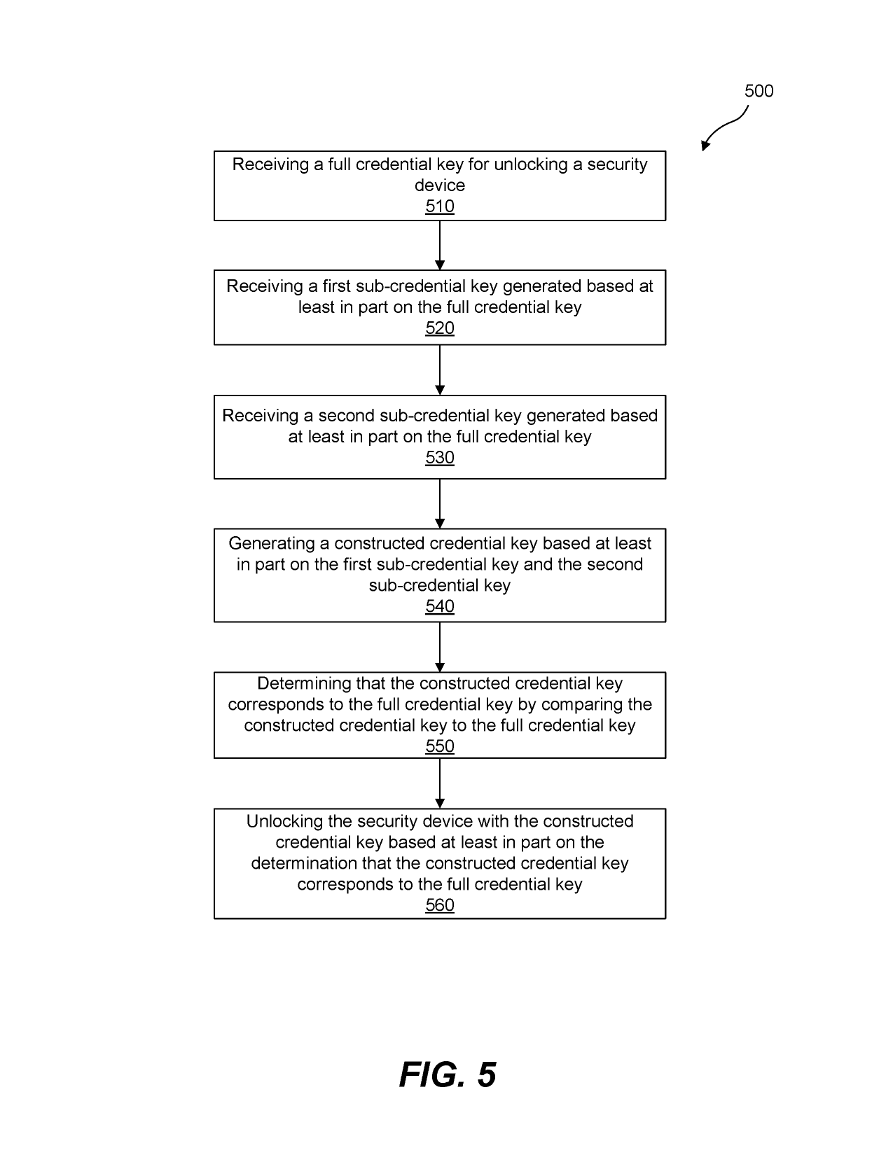

Another example communication condition may additionally or alternatively include a time requirement between each sub-credential key transmission. For example, the reader device 110 may require that each sub-credential key be received within a time threshold of each other to mitigate the risk of relay or timing attacks by malicious actors attempting to access the security device 112. Additionally, by limiting the window for the reader device 110 to accept sub-credential keys, this time requirement can decrease the risk that the reader device 110 can inadvertently receive sub-credential keys from other user devices other than the user devices 102a, 102b (e.g., from other users devices that may be nearby). FIGS. 4A-4C depict the transmission of sub-credential keys at different times. FIG. 4A depicts the first user device 102a transmitting the first sub-credential key to the reader device 110 at a first time 410 (e.g., based on a first time information, such as a timestamp, recorded by the reader device 110). The reader device 110 may start a first timer after receiving the first sub-credential key at the first time 410. FIG. 4B depicts the second user device 102b transmitting the second sub-credential key at a second time 420 (e.g., based on a second time information, such as a timestamp, recorded by the reader device 110) after the first user device 102a transmits the first sub-credential key at the first time 410. The reader device 110 may end the first timer after receiving the second sub-credential key. The reader device 110 may determine a first time period between the first time 410 and the second time 420. The reader device 110 may compare the first time period to a first time threshold. The first time threshold may be a pre-determined amount of time, such as 30 seconds, 1 minute, 2 minutes, 5 minutes, 10 minutes, 30 minutes, or the like) to determine if the second sub-credential key was received within the required first time threshold. If the first time period between the times 410, 420 is greater than the first time threshold, the reader device 110 may not accept the second sub-credential key. If the time period between the times 410, 420 is less than the time threshold, the reader device 110 may accept the second sub-credential key for use in later generating the constructed credential key.

In some embodiments, where the reader device 110 requires more than two sub-credential keys, the reader device 110 may start a second timer after receiving the second sub-credential key until the reader device 110 receives the next sub-credential key. For example, FIG. 4C depicts a third user device 402 transmitting a third sub-credential key at a third time 430 (e.g., based on a third time information, such as a timestamp, recorded by the reader device 110) after the second user device 102b transmits the second sub-credential key at the second time 420. In this example, the third sub-credential key may be the last sub-credential key required for the reader device 110 to generate the constructed sub-credential key. The reader device 110 may stop the second timer after receiving the third sub-credential key at the third time 430. The reader device 110 may determine a second time period between the third time 430 and the second time 420, and may compare the second time period to the first time threshold to determine whether to accept the third sub-credential key. In other embodiments, the second time period may be compared to a time threshold different than the first time threshold (e.g., having a different pre-determined amount of time).

The reader device 110 may also require that all the required sub-credential keys are received within a second time threshold after receiving the first sub-credential key at the first time 410. For example, where the third sub-credential key may be the last sub-credential key required for the reader device 110 to generate the constructed sub-credential key, the reader device 110 may start a third timer after receiving the first sub-credential key at the first time 410 and may end the third timer when the reader device 110 receives the third sub-credential key at the third time 430. The reader device 110 may determine a third time period between when the third sub-credential key was received at the third time 430 and the first sub-credential key was received at the first time 410. The reader device 110 may compare the third time period to a second time threshold. The second time threshold may be a predetermined amount of time, such as a second pre-determined time threshold 5 minute, 10 minutes, 15 minutes, 30 minutes, 45 minutes, or the like.

If all sub-credential keys are received within the second time threshold, the reader device 110 may accept all credential keys for use in generating the constructed credential key. If less than all the sub-credential keys are received within the second time threshold (e.g., if the difference between the third time 430 and first time 410 is greater than the second time threshold), then the reader device 110 may invalidate the access attempt and/or all accepted sub-credential keys (e.g., the first and second sub-credential keys from the user devices 102a, 102b that were previously accepted). In this example, a new set of sub-credential keys may be required in order to attempt to access the security device 112 again.

In some embodiments, the reader device 110 may transmit a notification to the user devices 102a, 102b, 402 that the access attempt and/or all accepted sub-credential keys are invalidated. The provisioning device 106 can then split the full credential key and issue a new set of sub-credential keys for the user devices 102a, 102b, 402 (e.g., similar to step 206) that is different from the initial set of sub-credential keys used in the first access attempt. The user devices 102a, 102b, 402 can then use this new set of sub-credential keys in another access attempt. Additionally or alternatively, in other embodiments, the reader device can require that the user devices 102a, 102b, 402 wait a period of time after the reader device 110 invalidates the access attempt and/or the sub-credential keys before attempting a subsequent access attempt. In an even further embodiment, where the provisioning device 106 transmitted sub-credential keys to other user devices in addition to user devices 102a, 102b, 402, the reader device 110 may require one or more sub-credential keys from those other user devices in a subsequent access attempt. These additional measures by the reader device 110 can minimize the risk of unauthorized access to the security device 112, such as where the initial access attempt may have been made by malicious actors.

The second time threshold corresponding to the pre-determined amount of time required to receive all sub-credential keys may be greater than the first time threshold corresponding to the pre-determined amount of time between corresponding receipts of each of the sub-credential key. In some embodiments, the second time threshold may be equal to or less than a sum of all of the first time thresholds, however, in other embodiments, the second time threshold may be greater than the sum of all the first time thresholds. In some embodiments, the third timer may start at the same time as the first timer. However, in other embodiments, where the reader device only requires two sub-credential keys, the first time threshold required between the receipt of each sub-credential key, and the second time threshold required between the receipt of the first sub-credential key and the last sub-credential key, may be the same. In this example, there may be no third timer.

With continued reference to FIG. 4C, another example communication condition may additionally or alternatively include an order requirement of the sub-credential keys to the reader device 110. Specifically, the reader device 110 may require that the sub-credential keys be transmitted to the reader device 110 in a particular order (e.g., a pre-determined order) in order for the reader device 110 to accept all the sub-credential keys to generate the full credential key. For example, the reader device 110 may require the reception of the first sub-credential key, then the reception of the second sub-credential key, and then the reception of the third sub-credential key in order to accept all the sub-credential keys to generate the full credential key. If the reader device 110 does not receive the sub-credential keys according to the order requirement, then the reader device 110 may not accept the sub-credential keys that are transmitted to the reader device 110 out of order. In some embodiments, transmitting the sub-credential keys out of order may result in the invalidation of the access attempt and/or the accepted sub-credential keys, as discussed above. Where the reader device 110 includes the order requirement, each of the sub-credential keys may include meta data that provides information regarding the specified order of the sub-credential keys. The provisioning device 106 may have included such meta data in each of the sub-credential keys when the provisioning device 106 split the full credential key and/or the user devices 102a, 102b, 402 may have included such meta data in each of the sub-credential keys prior to sending the sub-credential keys to the reader device 110.

Yet another example communication condition may include an authentication requirement. For example, one or more of the user devices 102a, 102b, 402 and/or the reader device 110 may require that the users of the user devices 102a, 102b, 402 authenticate their identity with the corresponding user devices 102a, 102b, 402 and/or the reader device 110. This authentication may include the users providing one or more of a user name and password, a personal identification number, a verification code sent to their email or messaging application, biometric verification (e.g., fingerprint scanning, facial recognition, or the like), or the like.

In some embodiments, the reader device 110 may transmit a notification to the user devices 102a, 102b, 402 noting whether the sub-credential keys were accepted or not. For example, the reader device 110 may transmit a notification indicating that all sub-credential keys were successfully accepted (e.g., all user devices 102a, 102b, 402 meets all communication conditions). However, if one or more of the user devices 102a, 102b, 402 does not meet a communication condition, the reader device 110 may transmit a notification indicating that at least one of the user devices 102a, 102b, 402 does not meet one or more of the communication conditions. In some embodiments, the reader device 110 may indicate which communication condition the user device(s) 102a, 102b, 402 does not meet.

In some embodiments, the reader device 110 may require less sub-credential keys for use in generating the constructed credential key than all of the available sub-credential keys transmitted by the provisioning device 106. For example, the reader device 110 may accept any two out of the three sub-credential keys of the user devices 102a, 102b, 402 to generate the constructed credential key as long as those sub-credential keys are transmitted according to the required communication conditions. In some examples, certain of the sub-credential keys may be mandatory in order to generate the constructed credential key. For example, the reader device 110 may require the reception of the first sub-credential key, and either the second or third sub-credential key from the user devices 102b, 402. In this example, the first sub-credential key (e.g., where the first user device 102a is a user device of an employee where the security device 112 is housed) may be mandatory while the second or third sub-credential keys can be interchangeably received by the reader device 110 (e.g., where the user devices 102b, 402 are user devices of two of the owners of the security device 112 that each have equal access privileges to the security device 112). In other embodiments, any number of the available sub-credential keys can be mandatory and/or interchangeably received. Although the above description discusses examples where the reader device 110 requires two or three sub-credential keys from the user devices 102a, 102b, 402, in other embodiments, the reader device may require sub-credential keys from four or more user devices.

Turning back to FIG. 2, at step 212, the reader device 110 may generate the constructed credential key to verify whether the user of the user devices 102a, 102b are authorized to access the security device 112. For example, the reader device 110 may use a polynomial algorithm with the accepted sub-credential keys to generate the constructed credential key. In one example, where the provisioning device 106 split the full credential keys according to Shamir’s secret algorithm, the reader device 110 may generate the constructed credential according to processes associated with Shamir’s secret algorithm.

The reader device 110 may then compare the constructed credential key to the full credential key received by the provisioning device 106. For example, the reader device 110 may compare the constructed credential key to the full credential key to determine if the constructed credential key matches the full credential key. If the constructed credential key and the full credential key matches, the reader device 110 can continue with the process. However, if the constructed credential key and the full credential key do not match, the reader device 110 may invalidate the access attempt and/or all accepted sub-credential keys, as discussed above.

At step 214, if the constructed credential key and the full credential key match, the reader device 110 may provide access to the users of the user devices 102a, 102b to the contents of the security device 112 by unlocking the security device 112.

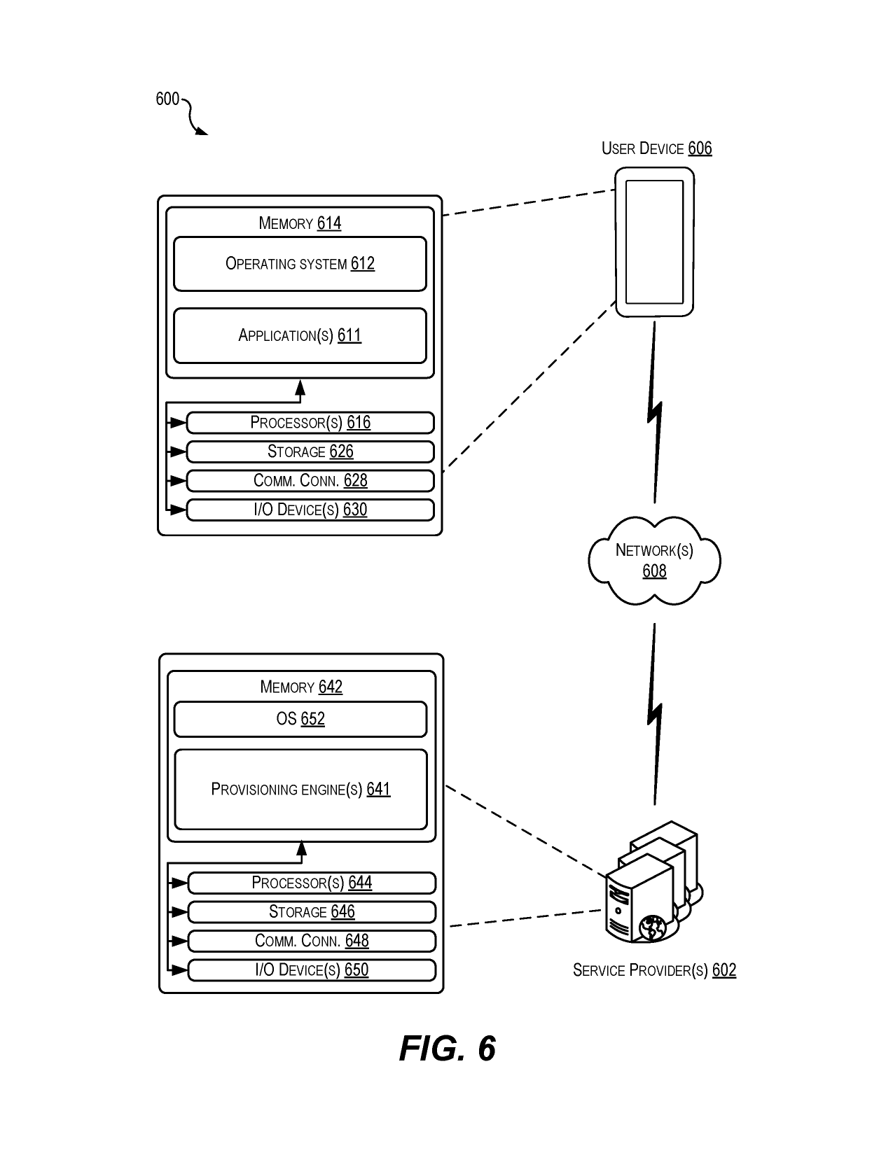

FIG. 5 depicts an example flowchart showing a process 500 for accessing a security device. Unless noted otherwise, the process 500 will be performed by the reader device 110.

At block 510, the reader device 110 can receive a full credential key for unlocking a security device. For example, the reader device 110 can receive a full credential key from the provisioning device 106.

At block 520, the reader device 110 can receive a first sub-credential key generated based at least in part on the full credential key. For example, the reader device 110 can receive a first sub-credential key from a first user device 102a. The first sub-credential key may be a first sub-credential key split from a full credential key by the provisioning device 106 according to an agreed upon algorithm such as Shamir’s secret sharing algorithm, XOR sharing, or the like. The reader device 110 can accept the first sub-credential key if the receipt of the first sub-credential key from the first user device 102a meets all of the communication conditions (e.g., one or more of a distance threshold, a time threshold, an order requirement, authentication requirement, or the like).

At block 530, the reader device 110 can receive a second sub-credential key generated based at least in part on the full credential key. For example, the reader device 110 can receive a second sub-credential key from a second user device 102b. The second sub-credential key may be a second sub-credential key split from a full credential key by the provisioning device 106 according to a communication protocol (e.g., the same communication protocol used to generate the first sub-credential key). The reader device 110 can accept the second sub-credential key if the receipt of the second sub-credential key from the second user device 102b meets all of the communication conditions.

At block 540, the reader device 110 may generate a constructed credential key based at least in part on the first sub-credential key and the second sub-credential key. For example, the reader device 110 may use a polynomial algorithm and/or a process that corresponds to the communication protocols that the provisioning device 106 used to split the full credential key into the sub-credential keys (e.g., according to an agreed upon algorithm, such as Shamir’s secret sharing algorithm, XOR sharing, or the like) with the accepted sub-credential keys to generate the constructed credential key.

At block 550, the reader device 110 may determine that the constructed credential key corresponds to the full credential key by comparing the constructed credential key to the full credential key. For example, the reader device 110 may compare the constructed credential key to the full credential key to determine that the constructed credential key matches the full credential key. However, in other embodiments, if the reader device 110 determines that the constructed credential key does not match the full credential key, the reader device 110 may, instead, invalidate the access attempt and/or all accepted sub-credential keys.

At block 560, the reader device 110 may unlock the security device with the constructed credential key based at least in part on the determination that the constructed credential key corresponds to the full credential key. For example, the reader device 110 can unlock the security device 110 once the reader device 110 determines that the constructed credential key matches the full credential key. The users of the user device 102a, 102b can access the contents of the security device 112 once the security device 112 is unlocked.

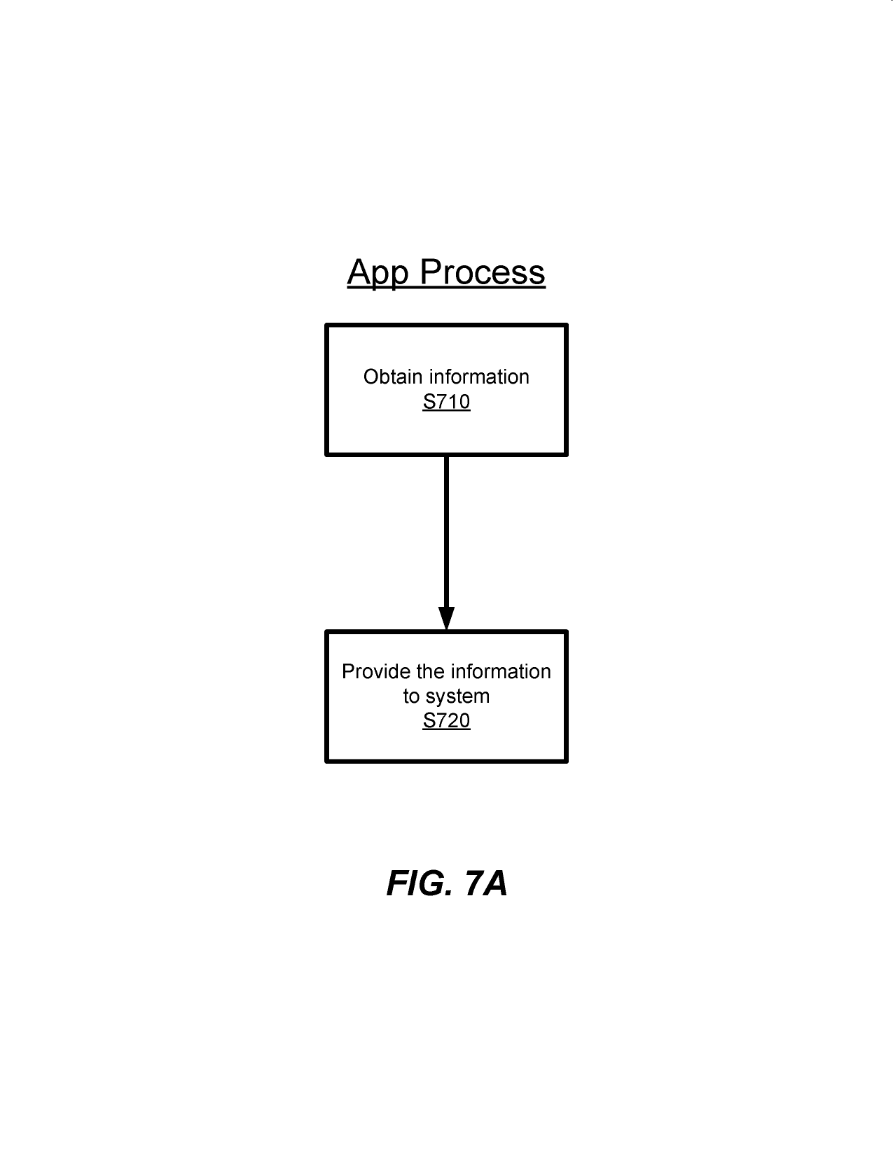

FIG. 6 illustrates an example architecture or environment 600 configured to implement techniques described herein, according to at least one example. In some examples, the example architecture or environment 600 may further be configured to enable a user device 606 and service provider computer 602 to share information. The service provider computer 602 is an example of the reader 110. The user device 606 is an example of the user devices 102a, 102b, 402. In some examples, the devices may be connected via one or more networks 608 (e.g., via Bluetooth, WiFi, the Internet, or the like). In some examples, the service provider computer 602 may be configured to implement at least some of the techniques described herein with reference to the user device 606.

In some examples, the networks 608 may include any one or a combination of many different types of networks, such as cable networks, the Internet, wireless networks, cellular networks, satellite networks, other private and/or public networks, or any combination thereof. While the illustrated example represents the user device 606 accessing the service provider computer 602 via the networks 608, the described techniques may equally apply in instances where the user device 606 interacts with the service provider computer 602 over a landline phone, via a kiosk, or in any other manner. It is also noted that the described techniques may apply in other client/server arrangements (e.g., set-top boxes, etc.), as well as in non-client/server arrangements (e.g., locally stored applications, peer–to-peer configurations, etc.).

As noted above, the user device 606 may be any type of computing device such as, but not limited to, a mobile phone, a smartphone, a personal digital assistant (PDA), a laptop computer, a desktop computer, a thin-client device, a tablet computer, a wearable device such as a smart watch, or the like. In some examples, the user device 606 may be in communication with the service provider computer 602 via the network 608, or via other network connections.

In one illustrative configuration, the user device 606 may include at least one memory 614 and one or more processing units (or processor(s)) 616. The processor(s) 616 may be implemented as appropriate in hardware, computer-executable instructions, firmware, or combinations thereof. Computer-executable instruction or firmware implementations of the processor(s) 616 may include computer-executable or machine-executable instructions written in any suitable programming language to perform the various functions described. The user device 606 may also include geo-location devices (e.g., a global positioning system (GPS) device or the like) for providing and/or recording geographic location information associated with the user device 606.

The memory 614 may store program instructions that are loadable and executable on the processor(s) 616, as well as data generated during the execution of these programs. Depending on the configuration and type of the user device 606, the memory 614 may be volatile (such as random access memory (RAM)) and/or non-volatile (such as read-only memory (ROM), flash memory, etc.). The user device 606 may also include additional removable storage and/or non-removable storage 626 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 614 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 614 and the additional storage 626, both removable and non-removable, are all examples of non-transitory computer-readable storage media. For example, non-transitory computer readable storage media may include volatile or non-volatile, removable or non-removable media implemented in any method or technology for storage of information such as computer-readable instructions, data structures, program modules, or other data. The memory 614 and the additional storage 626 are both examples of non-transitory computer storage media. Additional types of computer storage media that may be present in the user device 606 may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 606. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The user device 606 may also contain communications connection(s) 628 that allow the user device 606 to communicate with a data store, another computing device or server, user terminals, and/or other devices via the network 608. The user device 606 may also include I/O device(s) 630, such as a keyboard, a mouse, a pen, a voice input device, a touch screen input device, a display, speakers, a printer, etc.

Turning to the contents of the memory 614 in more detail, the memory 614 may include an operating system 612 and/or one or more application programs or services for implementing the features disclosed herein such as applications 611 (e.g., digital wallet, third-party applications, browser application, etc.). In some examples, the service provider computer 602 may also include a health application to perform similar techniques as described with reference to the user device 606. Similarly, at least some techniques described with reference to the service provider computer 602 may be performed by the user device 606.

The service provider computer 602 may also be any type of computing device such as, but not limited to, a collection of virtual or “cloud” computing resources, a remote server, a mobile phone, a smartphone, a PDA, a laptop computer, a desktop computer, a thin-client device, a tablet computer, a wearable device, a server computer, a virtual machine instance, etc. In some examples, the service provider computer 602 may be in communication with the user device 606 via the network 608, or via other network connections.

In one illustrative configuration, the service provider computer 602 may include at least one memory 642 and one or more processing units (or processor(s)) 644. The processor(s) 644 may be implemented as appropriate in hardware, computer-executable instructions, firmware, or combinations thereof. Computer-executable instruction or firmware implementations of the processor(s) 644 may include computer-executable or machine-executable instructions written in any suitable programming language to perform the various functions described.

The memory 642 may store program instructions that are loadable and executable on the processor(s) 644, as well as data generated during the execution of these programs. Depending on the configuration and type of service provider computer 602, the memory 642 may be volatile (such as RAM) and/or non-volatile (such as ROM, flash memory, etc.). The service provider computer 602 may also include additional removable storage and/or non-removable storage 646 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 642 may include multiple different types of memory, such as SRAM, DRAM, or ROM. While the volatile memory described herein may be referred to as RAM, any volatile memory that would not maintain data stored therein, once unplugged from a host and/or power, would be appropriate. The memory 642 and the additional storage 646, both removable and non-removable, are both additional examples of non-transitory computer-readable storage media.

The service provider computer 602 may also contain communications connection(s) 648 that allow the service provider computer 602 to communicate with a data store, another computing device or server, user terminals and/or other devices via the network 608. The service provider computer 602 may also include I/O device(s) 650, such as a keyboard, a mouse, a pen, a voice input device, a touch input device, a display, speakers, a printer, etc.

Turning to the contents of the memory 642 in more detail, the memory 642 may include an operating system 652 and/or one or more application programs or services for implementing the features disclosed herein including a provisioning engine(s) 641.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

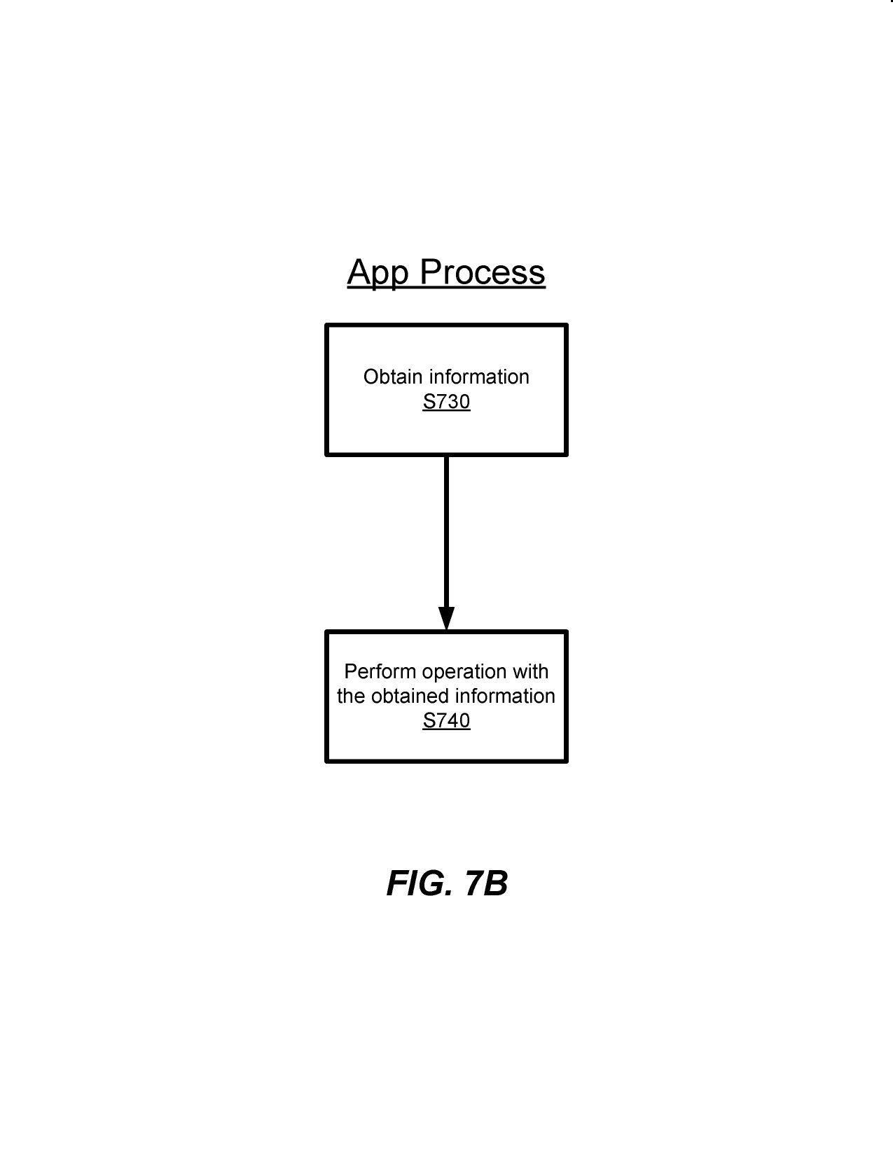

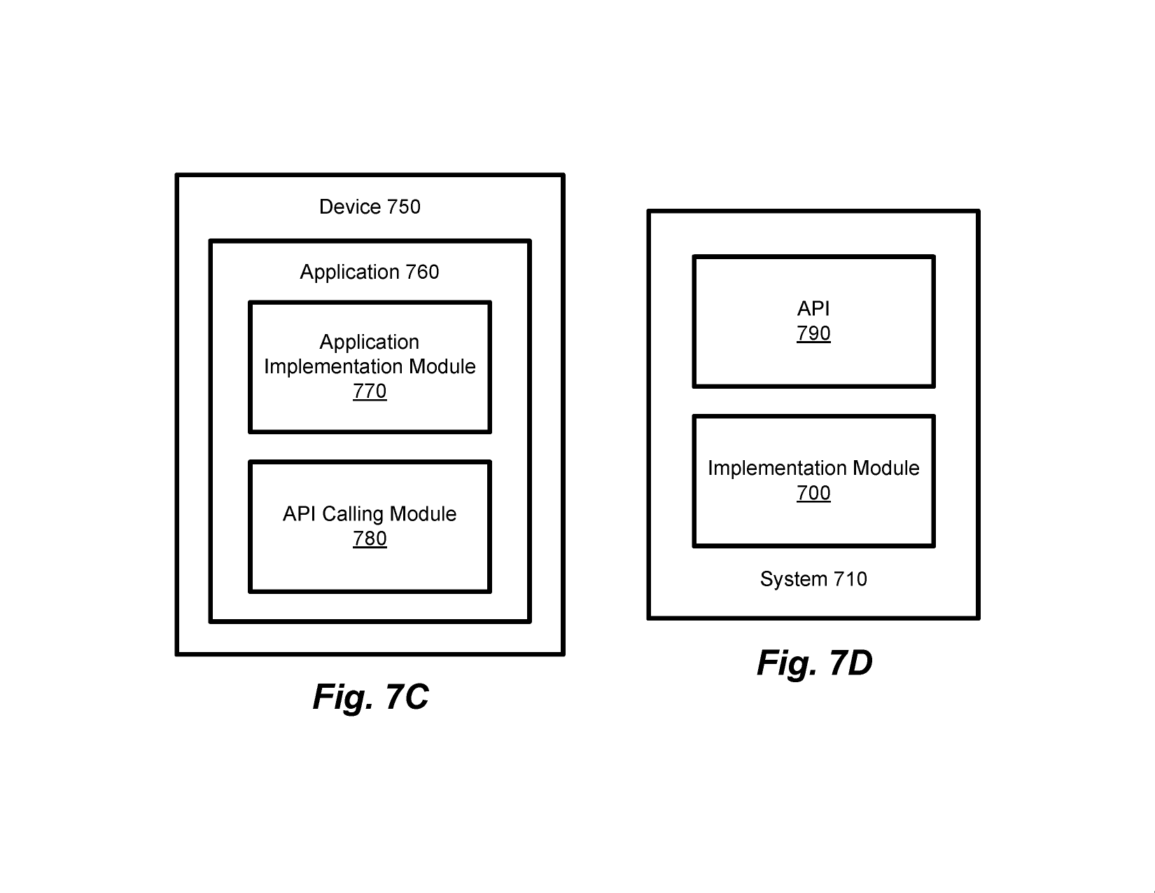

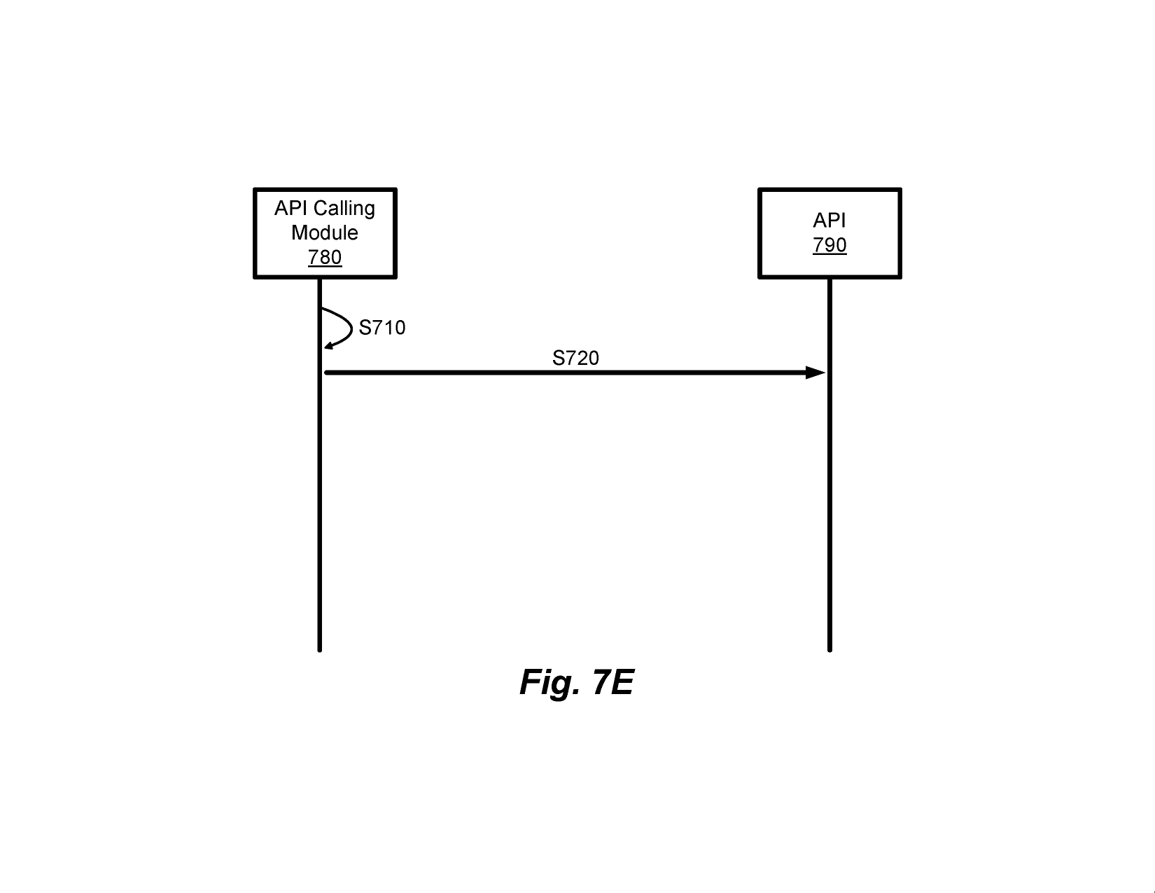

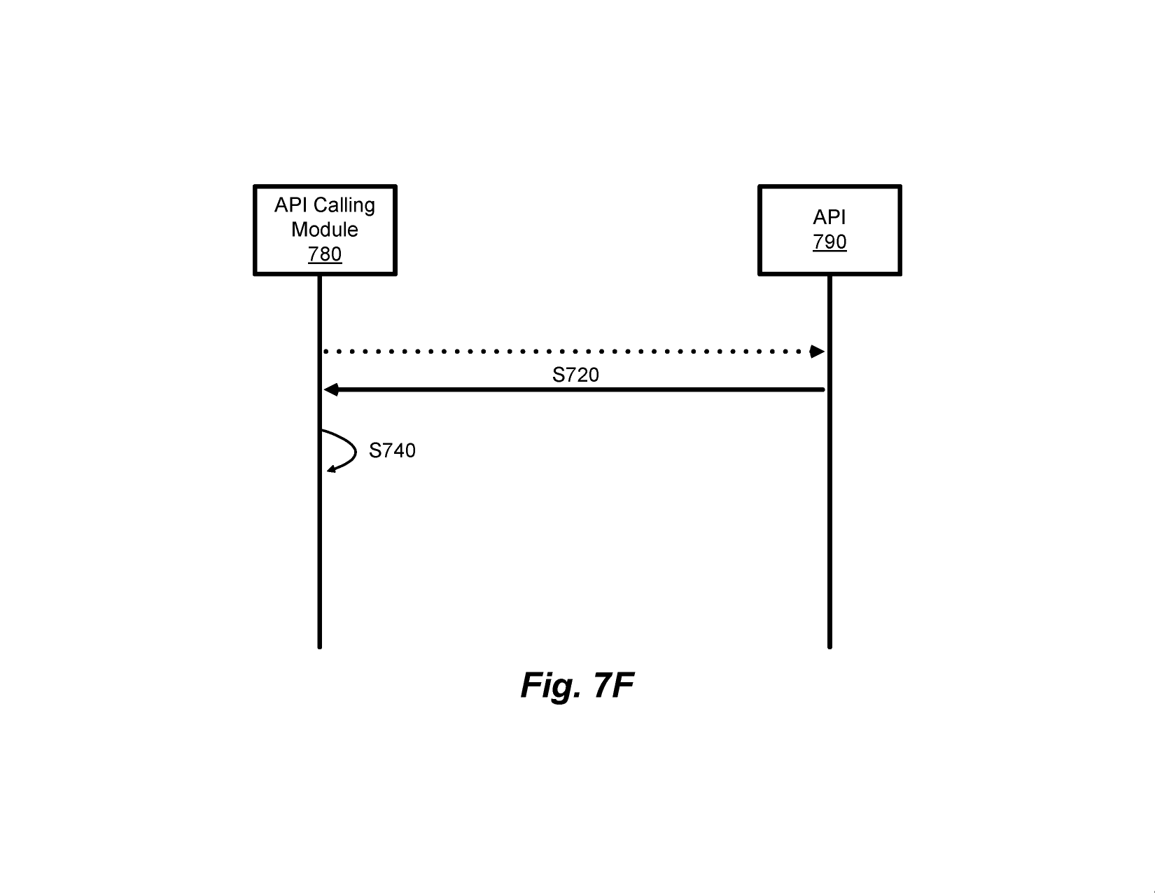

Implementations within the scope of the present disclosure include a computer-readable storage medium that encodes instructions organized as an application (e.g., application 760) that, when executed by one or more processing units, control an electronic device (e.g., device 750) to perform the method of FIG. 7B, the method of FIG. 7C, and/or one or more other processes and/or methods described herein.

It should be recognized that application 760 (shown in FG. 7D) can be any suitable type of application, including, for example, one or more of: an accessory companion application, a browser application, an application that functions as an execution environment for plug-ins, widgets or other applications, a fitness application, a health application, a digital payments application, a media application, a social network application, a messaging application, and/or a maps application. In some embodiments, application 760 is an application that is pre-installed on device 750 at purchase (e.g., a first party application). In other embodiments, application 760 is an application that is provided to device 750 via an operating system update file (e.g., a first party application or a second party application). In other embodiments, application 760 is an application that is provided via an application store. In some embodiments, the application store can be an application store that is pre-installed on device 750 at purchase (e.g., a first party application store). In other embodiments, the application store is a third-party application store (e.g., an application store that is provided by another application store, downloaded via a network, and/or read from a storage device).

Referring to FIG. 7B and FIG. 7F, application 760 obtains information (e.g., S710). In some embodiments, at S710, information is obtained from at least one hardware component of the device 750. In some embodiments, at S710, information is obtained from at least one software module of the device 750. In some embodiments, at S710, information is obtained from at least one hardware component external to the device 750 (e.g., a peripheral device, an accessory device, a server, etc.). In some embodiments, the information obtained at S710 includes positional information, time information, notification information, user information, environment information, electronic device state information, weather information, media information, historical information, event information, hardware information, and/or motion information. In some embodiments, in response to and/or after obtaining the information at S710, application 760 provides the information to a system (e.g., S720).

In some embodiments, the system (e.g., 710 shown in FIG. 7E) is an operating system hosted on the device 750. In some embodiments, the system (e.g., 710 shown in FIG. 7E) is an external device (e.g., a server, a peripheral device, an accessory, a personal computing device, etc.) that includes an operating system.

Referring to FIG. 7C and FIG. 7G, application 760 obtains information (e.g., S730). In some embodiments, the information obtained at S730 includes positional information, time information, notification information, user information, environment information electronic device state information, weather information, media information, historical information, event information, hardware information and/or motion information. In response to and/or after obtaining the information at S730, application 760 performs an operation with the information (e.g., S740). In some embodiments, the operation performed at S740 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 710 based on the information.

In some embodiments, one or more steps of the method of FIG. 7B and/or the method of FIG. 7C is performed in response to a trigger. In some embodiments, the trigger includes detection of an event, a notification received from system 710, a user input, and/or a response to a call to an API provided by system 710.

In some embodiments, the instructions of application 760, when executed, control device 750 to perform the method of FIG. 7B and/or the method of FIG. 7C by calling an application programming interface (API) (e.g., API 790) provided by system 710. In some embodiments, application 760 performs at least a portion of the method of FIG. 7B and/or the method of FIG. 7C without calling API 790.

In some embodiments, one or more steps of the method of FIG. 7B and/or the method of FIG. 7C includes calling an API (e.g., API 790) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 7D, device 750 is illustrated. In some embodiments, device 750 is a personal computing device, a smart phone, a smart watch, a fitness tracker, a head mounted display (HMD) device, a media device, a communal device, a speaker, a television, and/or a tablet. As illustrated in FIG. 7D, device 750 includes application 760 and operating system (e.g., system 710 shown in FIG. 7E). Application 760 includes application implementation module 770 and API calling module 780. System 710 includes API 790 and implementation module 700. It should be recognized that device 750, application 760, and/or system 710 can include more, fewer, and/or different components than illustrated in FIG. 7D and 7E.

In some embodiments, application implementation module 770 includes a set of one or more instructions corresponding to one or more operations performed by application 760. For example, when application 760 is a messaging application, application implementation module 770 can include operations to receive and send messages. In some embodiments, application implementation module 770 communicates with API calling module to communicate with system 710 via API 790 (shown in FIG. 7E).

In some embodiments, API 790 is a software module (e.g., a collection of computer-readable instructions) that provides an interface that allows a different module (e.g., API calling module 780) to access and/or use one or more functions, methods, procedures, data structures, classes, and/or other services provided by implementation module 700 of system 710. For example, API-calling module 780 can access a feature of implementation module 700 through one or more API calls or invocations (e.g., embodied by a function or a method call) exposed by API 790 and can pass data and/or control information using one or more parameters via the API calls or invocations. In some embodiments, API 790 allows application 760 to use a service provided by a Software Development Kit (SDK) library. In other embodiments, application 760 incorporates a call to a function or method provided by the SDK library and provided by API 790 or uses data types or objects defined in the SDK library and provided by API 790. In some embodiments, API-calling module 780 makes an API call via API 790 to access and use a feature of implementation module 700 that is specified by API 790. In such embodiments, implementation module 700 can return a value via API 790 to API-calling module 780 in response to the API call. The value can report to application 760 the capabilities or state of a hardware component of device 750, including those related to aspects such as input capabilities and state, output capabilities and state, processing capability, power state, storage capacity and state, and/or communications capability. In some embodiments, API 790 is implemented in part by firmware, microcode, or other low level logic that executes in part on the hardware component.

In some embodiments, API 790 allows a developer of API-calling module 780 (which can be a third-party developer) to leverage a feature provided by implementation module 700. In such embodiments, there can be one or more API-calling modules (e.g., including API-calling module 780) that communicate with implementation module 700. In some embodiments, API 790 allows multiple API-calling modules written in different programming languages to communicate with implementation module 700 (e.g., API 790 can include features for translating calls and returns between implementation module 700 and API-calling module 780) while API 790 is implemented in terms of a specific programming language. In some embodiments, API-calling module 780 calls APIs from different providers such as a set of APIs from an OS provider, another set of APIs from a plug-in provider, and/or another set of APIs from another provider (e.g., the provider of a software library) or creator of the another set of APIs.

Examples of API 790 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API. In some embodiments the sensor API is an API for accessing data associated with a sensor of device 750. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 700 is a system (e.g., operating system, server system) software module (e.g., a collection of computer-readable instructions) that is constructed to perform an operation in response to receiving an API call via API 790. In some embodiments, implementation module 700 is constructed to provide an API response (via API 790) as a result of processing an API call. By way of example, implementation module 700 and API-calling module 180 can each be any one of an operating system, a library, a device driver, an API, an application program, or other module. It should be understood that implementation module 700 and API-calling module 780 can be the same or different type of module from each other. In some embodiments, implementation module 700 is embodied at least in part in firmware, microcode, or other hardware logic.

In some embodiments, implementation module 700 returns a value through API 790 in response to an API call from API-calling module 780. While API 790 defines the syntax and result of an API call (e.g., how to invoke the API call and what the API call does), API 790 might not reveal how implementation module 700 accomplishes the function specified by the API call. Various API calls are transferred via the one or more application programming interfaces between API-calling module 780 and implementation module 700. Transferring the API calls can include issuing, initiating, invoking, calling, receiving, returning, and/or responding to the function calls or messages. In other words, transferring can describe actions by either of API-calling module 780 or implementation module 700. In some embodiments, a function call or other invocation of API 790 sends and/or receives one or more parameters through a parameter list or other structure.

In some embodiments, implementation module 700 provides more than one API, each providing a different view of or with different aspects of functionality implemented by implementation module 700. For example, one API of implementation module 700 can provide a first set of functions and can be exposed to third party developers, and another API of implementation module 700 can be hidden (e.g., not exposed) and provide a subset of the first set of functions and also provide another set of functions, such as testing or debugging functions which are not in the first set of functions. In some embodiments, implementation module 700 calls one or more other components via an underlying API and thus be both an API calling module and an implementation module. It should be recognized that implementation module 700 can include additional functions, methods, classes, data structures, and/or other features that are not specified through API 790 and are not available to API calling module 780. It should also be recognized that API calling module 780 can be on the same system as implementation module 700 or can be located remotely and access implementation module 700 using API 790 over a network. In some embodiments, implementation module 700, API 790, and/or API-calling module 780 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, process 500 (FIG. 5) is performed at a first computer system (as described herein) via a system process (e.g., an operating system process, a server system process) that is different from one or more applications executing and/or installed on the first computer system.

In some embodiments, process 500 (FIG. 5) is performed at a first computer system (as described herein) by an application that is different from a system process. In some embodiments, the instructions of the application, when executed, control the first computer system to perform process 500 (FIG. 5) by calling an application programming interface (API) provided by the system process. In some embodiments, the application performs at least a portion of process 500 without calling the API.

In some embodiments, the application is an accessory companion application that is constructed for processing communication and management between the first computer system and an accessory device (e.g., a wearable device, such as, for example, a watch).

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform the method shown in FIG. 7 by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, the API 790 defines a first API call that can be provided by API calling module 790. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 750) that runs the application. In some embodiments, the implementation module is included in an electronic device that is separate from the device that runs the application.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

The various examples further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java^{®}, C, C# or C++, or any scripting language, such as Perl, Python or TCL, as well as combinations thereof. The server(s) may also include database servers, including without limitation those commercially available from Oracle^{®}, Microsoft^{®}, Sybase^{®,} and IBM^{®}.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

As described above, one aspect of the present technology is the gathering and use of data available from various sources to provide a comprehensive and complete window to a user’s personal health record. The present disclosure contemplates that in some instances, this gathered data may include personally identifiable information (PII) data that uniquely identifies or can be used to contact or locate a specific person. Such personal information data can include demographic data, location-based data, telephone numbers, email addresses, Twitter ID's, home addresses, data or records relating to a user’s health or level of fitness (e.g., vital sign measurements, medication information, exercise information), date of birth, health record data, or any other identifying or personal or health information.

The present disclosure recognizes that the use of such personal information data, in the present technology, can be used to the benefit of users. For example, the personal information data can be used to provide enhancements to a user’s personal health record. Further, other uses for personal information data that benefit the user are also contemplated by the present disclosure. For instance, health and fitness data may be used to provide insights into a user’s general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the U.S., collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services or other services relating to health record management, the present technology can be configured to allow users to select to "opt in" or "opt out" of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A computer-implemented method comprising:
receiving, by a reader device from a provisioning device, a full credential key for unlocking a security device;
receiving, by the reader device from a first electronic device, a first sub-credential key generated based at least in part on the full credential key;
receiving, by the reader device from a second electronic device, a second sub-credential key generated based at least in part on the full credential key;
generating, by the reader device, a constructed credential key based at least in part on the first sub-credential key and the second sub-credential key;
determining, by the reader device, that the constructed credential key corresponds to the full credential key by comparing the constructed credential key to the full credential key; and
unlocking, by the reader device, the security device with the constructed credential key based at least in part on the determination that the constructed credential key corresponds to the full credential key.

2. The computer-implemented method of claim 1, wherein:
receiving the first sub-credential key includes receiving the first sub-credential key at a first time and receiving the second sub-credential key includes receiving the second sub-credential key at a second time after the first time; and
generating the constructed credential key includes generating the constructed credential key when a first time difference between the second time and the first time is less than a first pre-determined time threshold.

3. The computer-implemented method of claim 2, further comprising receiving, by the reader device from a third electronic device, a third sub-credential key at a third time after the second time, wherein generating the constructed credential key includes generating the constructed credential key based at least in part on the third sub-credential key.

4. The computer-implemented method of claim 3, wherein generating the constructed credential key includes generating the constructed credential key when a second time difference between the third time and the second time is less than the first pre-determined time threshold.

5. The computer-implemented method of claim 4, wherein generating the constructed credential key includes generating the constructed credential key when a third time difference between the third time and the first time is less than a second pre-determined time threshold different than the first pre-determined time threshold.

6. The computer-implemented method of claim 1, further comprising determining, by the reader device, a first distance between the first electronic device and the reader device, and a second distance between the second electronic device and the reader device, wherein generating the constructed credential key includes generating the constructed credential key when the first distance and the second distance are each less than a pre-determined distance threshold.

7. The computer-implemented method of claim 1, further comprising receiving, by the reader device from a third electronic device, a third sub-credential key, wherein generating the constructed credential key includes generating the constructed credential key without the third sub-credential key.

8. The computer-implemented method of claim 1, wherein receiving the first sub-credential key and the second sub-credential key includes receiving the first sub-credential key and the second sub-credential key through at least one of a near-field communication protocol, a Bluetooth® low energy protocol, or an ultra-wideband protocol.

9. The computer-implemented method of claim 8, wherein receiving the first sub-credential key and the second sub-credential key includes receiving the first sub-credential key and the second sub-credential key through an Aliro™ protocol.

10. The computer-implemented method of claim 1, wherein generating the constructed credential key includes generating the constructed credential key through a process associated with a cryptographic algorithm.

11. The computer-implemented method of claim 1, wherein determining that the constructed credential key corresponds to the full credential key includes determining that the constructed credential key matches the full credential key.

12. One or more non-transitory computer-readable media comprising computer-executable instructions that, when executed by one or more processors, cause the one or more processors to perform operations comprising:
receiving, by a reader device from a provisioning device, a full credential key for unlocking a security device;
receiving, by the reader device from a first electronic device, a first sub-credential key generated based at least in part on the full credential key;
receiving, by the reader device from a second electronic device, a second sub-credential key generated based at least in part on the full credential key;
generating, by the reader device, a constructed credential key based at least in part on the first sub-credential key and the second sub-credential key;
determining, by the reader device, that the constructed credential key corresponds to the full credential key by comparing the constructed credential key to the full credential key; and
unlocking, by the reader device, the security device with the constructed credential key based at least in part on the determination that the constructed credential key corresponds to the full credential key.

13. The one or more non-transitory computer-readable media of claim 12, wherein:
receiving the first sub-credential key includes receiving the first sub-credential key at a first time and receiving the second sub-credential key includes receiving the second sub-credential key at a second time after the first time; and
generating the constructed credential key includes generating the constructed credential key when a first time difference between the second time and the first time is less than a first pre-determined time threshold.

14. The one or more non-transitory computer-readable media of claim 13, further comprising receiving, by the reader device from a third electronic device, a third sub-credential key at a third time after the second time, wherein generating the constructed credential key includes generating the constructed credential key based at least in part on the third sub-credential key.

15. The one or more non-transitory computer-readable media of claim 14, wherein generating the constructed credential key includes generating the constructed credential key when a second time difference between the third time and the second time is less than the first pre-determined time threshold.

16. The one or more non-transitory computer-readable media of claim 15, wherein generating the constructed credential key includes generating the constructed credential key when a third time difference between the third time and the first time is less than a second pre-determined time threshold different than the first pre-determined time threshold.

17. The one or more non-transitory computer-readable media of claim 12, further comprising determining, by the reader device, a first distance between the first electronic device and the reader device, and a second distance between the second electronic device and the reader device, wherein generating the constructed credential key includes generating the constructed credential key when the first distance and the second distance are each less than a pre-determined distance threshold.

18. A system comprising:
a memory comprising computer-executable instructions; and
a processor configured to access the memory and execute the computer-executable instructions to at least:
receive, by a reader device from a provisioning device, a full credential key for unlocking a security device;
receive, by the reader device from a first electronic device, a first sub-credential key generated based at least in part on the full credential key;
receive, by the reader device from a second electronic device, a second sub-credential key generated based at least in part on the full credential key;
generate, by the reader device, a constructed credential key based at least in part on the first sub-credential key and the second sub-credential key;
determine, by the reader device, that the constructed credential key corresponds to the full credential key by comparing the constructed credential key to the full credential key; and
unlock, by the reader device, the security device with the constructed credential key based at least in part on the determination that the constructed credential key corresponds to the full credential key.

19. The system of claim 18, wherein:
receiving the first sub-credential key includes receiving the first sub-credential key at a first time and receiving the second sub-credential key includes receiving the second sub-credential key at a second time after the first time; and
generating the constructed credential key includes generating the constructed credential key when a first time difference between the second time and the first time is less than a first pre-determined time threshold.

20. The system of claim 18, further comprising determining, by the reader device, a first distance between the first electronic device and the reader device, and a second distance between the second electronic device and the reader device, wherein generating the constructed credential key includes generating the constructed credential key when the first distance and the second distance are each less than a pre-determined distance threshold.
